(19) United States
(12) Patent Application Publication
(10) Pub. No.: US 2009/0290729 A1
(43) Pub. Date: Nov. 26, 2009

(54) CATEGORIZATION PLATFORM, METHOD FOR CATEGORIZATION AND METHOD FOR MICROPHONE ARRAY MANUFACTURING

(75) Inventor: Ming Zhang, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/123,502

(22) Filed: May 20, 2008

(51) Int. Cl. H04R 3/00

(52) U.S. Cl. 381/122

(57) ABSTRACT

The invention provides a categorization platform and method for microphone array manufacturing. The categorization platform is attachable to a test microphone, comprising a digital signal processor. The digital signal processor categorizes the test microphone based on characteristics of the test microphone. The characteristics of the test microphone are phase mismatch, sensitivity mismatch or impedance mismatch in comparison with a reference microphone.

### BACKGROUND OF THE INVENTION

1. Field of the Invention

The invention relates to a microphone array, and in particular, to a method for categorizing microphones for manufacturing microphone arrays.

2. Description of the Related Art

A microphone array is an integrated voice receiver, whereby a plurality of microphones are used to cooperatively acquire sound. Conventionally, two or more microphones are arranged in a predetermined manner to form the microphone array. For example, the microphones may be separately positioned with predetermined distances, so that a digital signal processor can distinguish voice inputs from ambient noises. The microphone array is typically made up of omnidirectional microphones; however, sometimes unidirectional microphones may also be used.

A microphone array is classified into different types, based upon microphone distribution or distances between adjacent microphones. As such, different types of microphone arrays have different distributions and adjacent microphone distances. For example, a large-sized microphone array may have large adjacent microphone distances therebetween D₁, which is, for example, larger than 50 mm (50 mm<D₁). Similarly, a medium-sized microphone array may have average adjacent microphone distances therebetween D₂, which is, for example, 21 mm to 50 mm (21 mm<D₂<=50 mm), and a small-sized microphone array may have small adjacent microphone distances therebetween D₃, which is, for example, smaller than 21 mm (D₃<21 mm).

As known for those skilled in the art, although microphones may be manufactured from the same manufacturing line with the same specifications, mismatch always occurs. Different types of mismatch include: phase mismatch, sensitivity mismatch and impedance mismatch. Phase mismatch causes variation in delay times between signals received by the microphones. Meanwhile, sensitivity mismatch causes variations in amplitude, and impedance mismatch causes signal distortion for electronic circuits. For an ideal microphone array, two adjacent microphones are perfectly matched. However, in reality, mismatch is assumed and compensated for before a beam from received signals is formed. When designing a microphone array, distance between adjacent microphones is directed related to maximum allowable mismatch between the adjacent microphones. For example, a small-sized microphone array may require more perfectly matched microphones, while a large-sized microphone array may allow for more mismatched microphones. Specifically, if a small-sized microphone array comprises more mismatched microphones, the small-sized microphone array would not operate properly.

Conventionally, a specific type of microphone array is manufactured at a time. As such, various criteria must be met when manufacturing the microphone array, such as phase delay mismatch or sensitivity mismatch of the microphones within the microphone array. FIG. 1a is a flowchart of a conventional microphone array manufacturing process. In step 101, a plurality of sample microphones are provided in a storehouse, with untested characteristics. In step 103, one of the sample microphones is chosen and fixed onto a manufacturing platform. In step 105, a test process is performed to estimated the characteristics of the sample microphone. The characteristics herein particularly refers to the phase delay of a sample microphone. When the phase delay is estimated, step 107 is processed. In step 107, it is determined whether the phase delay has met the criteria of the microphone array. If the criteria have not been met, the tested microphone is returned to the storehouse, and the process loops back to step 103, wherein another microphone from the storehouse is chosen for characteristics tests and criteria checks. Only when the criteria are met, will the sample microphone be selected to be used in step 109. In step 109, the particular type of microphone array is manufactured with the selected sample microphones.

As shown in the conventional manufacturing process, when a particular type of microphone is manufactured, the sample microphones within a storehouse must be tested before proceeding with the manufacturing process. If there are various types of microphone arrays to be manufactured, the tests and criteria checks would be required to be repeatedly performed, resulting in a significantly inefficient and inconvenient manufacturing process. Thus, it is desirable to provide an improved manufacturing method, whereby the repeated tests and criteria checks are reduced.

### BRIEF SUMMARY OF THE INVENTION

The invention provides a categorization platform and method for categorizing a microphone before manufacturing a microphone array. The categorization platform is attachable to a test microphone, comprising a reference microphone, a speaker and a digital signal processor. The test microphone is positioned at a predetermined distance from the reference microphone. The speaker is used to generate a calibration signal. The digital signal processor performs a diagnostic test to determine characteristics of the test microphone in response to the calibration signal, and categorizes the test microphone based on characteristics of the test microphone.

When performing the diagnostic process, the digital signal processor provides a calibration signal to the speaker, whereby a first audio signal and a second audio signal respectively acquired by the reference microphone and the test microphone is received. The digital signal processor analyzes the first audio signal and the second audio signal to determine characteristics of the test microphone.

One characteristic may comprise phase mismatch between the reference microphone and the test microphone. The characteristic is determined by the digital signal processor by comparing phases of the first audio signal and the second audio signal. When performing the categorization process, the digital signal processor compares the phase mismatch with a criteria table comprising a plurality of categorized groups, wherein each categorized group corresponds to a mismatch range. If the phase mismatch falls into one of the mismatch ranges, the test microphone is appropriately categorized into the corresponding group. Conversely, if the phase mismatch does not fall into any of the mismatch ranges, the test microphone is appropriately assessed as being defective.

In an alternative embodiment, the characteristic may comprise sensitivity mismatch between the reference microphone and the test microphone. The characteristic is determined by the digital signal processor by comparing amplitudes of the first audio signal and the second audio signal. When performing the categorization process, the digital signal processor compares the sensitivity mismatch with a criteria table comprising a plurality of categorized groups, wherein each categorized group corresponds to a mismatch range. If the sensitivity mismatch falls into one of the mismatch ranges, the test microphone is appropriately categorized into the corresponding group. If the sensitivity mismatch does not fall into any of the mismatch ranges, the test microphone is appropriately assessed as being defective.

In another alternative embodiment, the characteristic may comprise impedance mismatch between the reference microphone and the test microphone. Similarly, the digital signal processor compares the impedance mismatch with a criteria table comprising a plurality of categorized groups, wherein each categorized group corresponds to a mismatch range. If the impedance mismatch falls into one of the mismatch ranges, the test microphone is appropriately categorized into the corresponding group. If the impedance mismatch does not fall into any of the mismatch ranges, the test microphone is appropriately assessed as being defective. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1a is a flowchart of conventional microphone array manufacturing process;

FIG. 1b shows an embodiment of a categorization platform according to the invention;

FIG. 2 is a flowchart of an embodiment of a testing method according to the invention;

FIG. 3 is a flowchart of a diagnostic test according to the embodiment of FIG. 2;

FIG. 4a is a flowchart of a categorization process according to the embodiment of FIG. 2; and

FIG. 4b shows a criteria table as a basis for microphone categorization according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

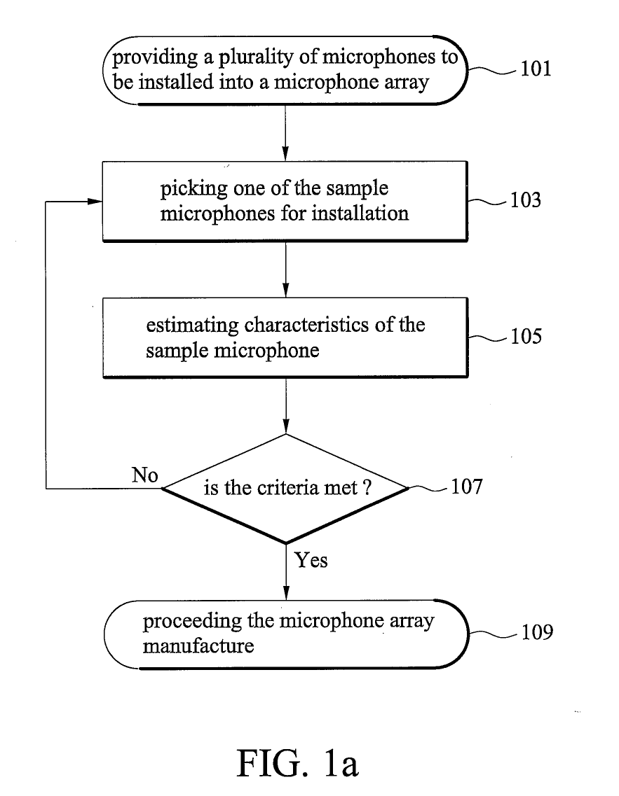

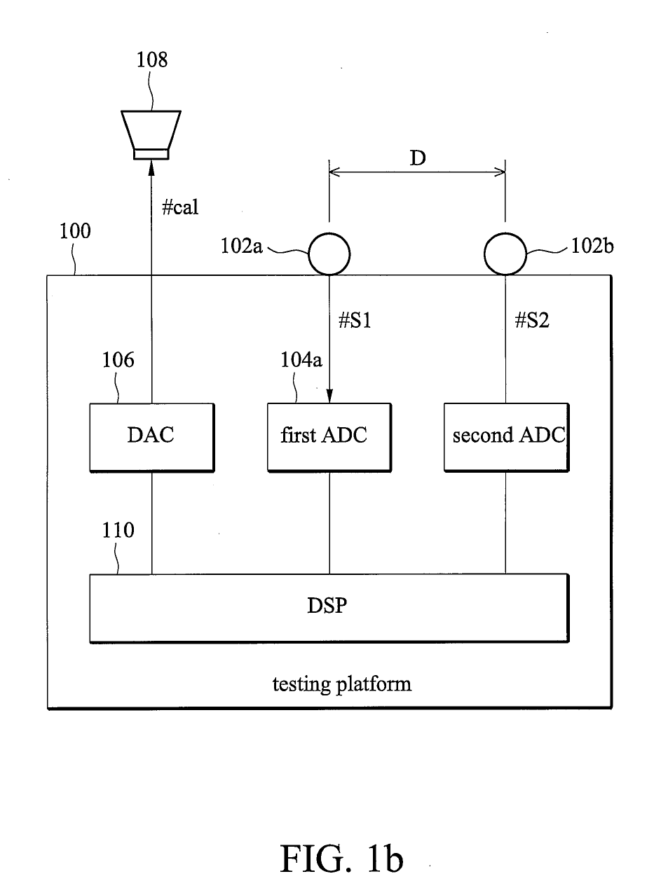

FIG. 1b shows an embodiment of a categorization platform according to the invention. In the categorization platform 100, a reference microphone 102a and a test microphone 102b are positioned and separated by a predetermined distance D. The reference microphone 102a may be a previously calibrated microphone, serving as a standard for all test microphones 102b to be compared and tested. The predetermined distance D may be adjustable, and preferably equal to the distance for the smallest microphone array which is to be manufactured. The categorization platform 100 may comprise a digital signal processor (DSP) 110, controlled by software programs, to perform a diagnostic test and a categorization process. When performing the diagnostic test, a speaker 108 is controlled by the DSP 110 to generate a calibration signal #cal. The calibration signal #cal is used to calibrate the reference microphone 102a and test microphone 102b, such that a first audio signal #S1 and a second audio signal #S2 are respectively generated for further analysis. The DSP 110 then analyzes the first audio signal #S1 and second audio signal #S2 to determine characteristics of the test microphone 102b. Next, the categorization process is performed based on characteristics of the test microphone 102b. In this way, the test microphone 102b can be categorized into a proper group for manufacturing of a particular type of microphone array.

In the categorization platform 100, the first ADC 104a, the second ADC 104b and the DAC 106 are provided as essential components for signal processing. The first ADC 104a is coupled to the reference microphone 102a, digitizing the first audio signal #S1 before the first audio signal #S1 is sent to the DSP 110. Similarly, the second ADC 104b is coupled to the test microphone 102b, digitizing the second audio signal #S2 before the second audio signal #S2 is sent to the DSP 110. The DAC 106 is dedicated to analogize the calibration signal #cal output from the DSP 110 before the calibration signal #cal is sent to the speaker 108.

When a test microphone 102b is positioned in place, a diagnostic test is initialized. The DSP 110 provides a calibration signal #cal to the speaker 108, and the speaker 108 broadcasts the calibration signal #cal such that the reference microphone 102a and the test microphone 102b can receive the calibration signal #cal. Consequently, a first audio signal #S1 and a second audio signal #S2 are respectively generated by the reference microphone 102a and the test microphone 102b, comprising the signals related to the calibration signal #cal. The first audio signal #S1 and second audio signal #S2 are sent to the DSP 110 respectively through the first ADC 104a and the second ADC 104b, allowing the DSP 110 to analyze the first audio signal #S1 and the second audio signal #S2 to determine characteristics of the test microphone 102b.

In the embodiment, the characteristic may be phase mismatch, sensitivity mismatch or impedance mismatch between the reference microphone 102a and the test microphone 102b. For example, if the phase match is the determining characteristic, the DSP 110 compares phases of the first audio signal #S1 and the second audio signal #S2 to determine the phase mismatch. Since the reference microphone 102a and test microphone 102b simultaneously receives the same calibration signal #cal, the phase difference therebetween can be easily determined. Thereafter, a categorization process is initialized.

To facilitate the categorization process, a criteria table is provided, comprising a plurality of categorized groups, wherein each categorized group corresponds to a mismatch range and each mismatch range corresponds to different microphone array types. As previously mentioned, different microphone array types have different allowable mismatch ranges. Thus, the criteria table allows a test microphone 102b to be categorized into a proper microphone array type according to its mismatch range. Various characteristics may also be jointly considered when performing the categorization process. For example, a phase mismatch criteria table, a sensitivity mismatch criteria table and an impedance criteria table may be simultaneously provided as references for the categorization process, such that a test microphone 102b may be precisely categorized into a particular group where all three mismatch criteria are met.

When the phase mismatch is the determining characteristic for categorization, the DSP 110 compares the phase mismatch with the phase mismatch criteria table. If the phase mismatch falls into one of the mismatch ranges, the test microphone 102b is categorized into a corresponding group. If the phase mismatch does not fall into any of the mismatch ranges, the test microphone 102b is assessed as being defective.

Similarly, when the sensitivity mismatch between the reference microphone 102a and the test microphone 102b is the determining characteristic for categorization, the DSP 110 compares amplitudes of the first audio signal #S1 and the second audio signal #S2 to determine the sensitivity mismatch. A sensitivity mismatch criteria table may be provided, comprising a plurality of categorized groups, wherein each categorized group corresponds to a mismatch range. If the sensitivity mismatch falls into one of the mismatch ranges, the test microphone 102b is categorized into a corresponding group. Conversely, if the sensitivity mismatch does not fall into any of the mismatch ranges, the test microphone 102b is assessed as being defective.

Furthermore, when impedance mismatch between the reference microphone 102a and the test microphone 102b is the determining characteristic, the DSP 110 compares the impedance mismatch with an impedance mismatch criteria table and categorizes the test microphone 102b into a corresponding mismatch range group. If the impedance mismatch does not fall into any of the mismatch ranges, the test microphone 102b is assessed as being defective.

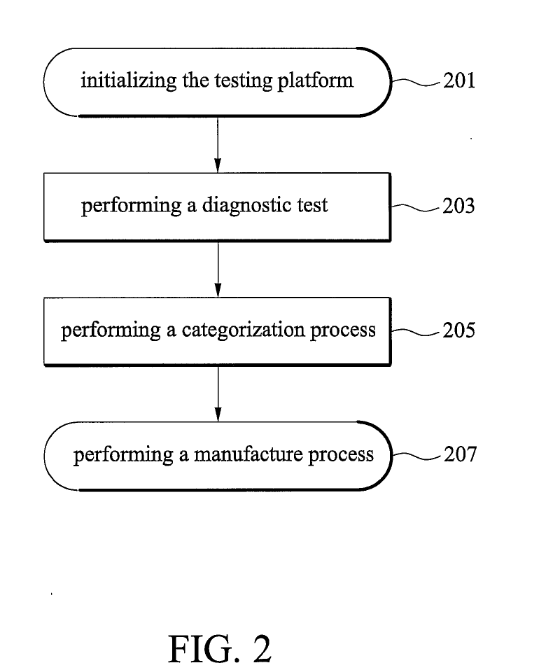

FIG. 2 is a flowchart of an embodiment of a testing method according to the invention. For manufacturing of a microphone array, a diagnostic test and a categorization process are performed on the test microphone 102b, before the microphone array is manufactured. In step 201, a testing environment is initialized to test a test microphone 102b. The test microphone 102b is attached to the categorization platform 100, separated from the reference microphone 102a by a predetermined distance D. In step 203, a diagnostic test is performed. A calibration signal #cal is broadcasted from a speaker 108, and the reference microphone 102a and test microphone 102b simultaneously receive the calibration signal #cal to generate a first audio signal #S1 and a second audio signal #S2. Characteristics of the test microphone 102b are thereby determined by analyzing the differences between the first audio signal #S1 and the second audio signal #S2. In step 205, a categorization process is performed based on the determined characteristics, such that the test microphone 102b can be assigned to a proper microphone array type. In step 207, when a sufficient number of test microphones 102b have been categorized, the microphone array manufacturing process is initialized comprising the appropriate categorized test microphone 102b type.

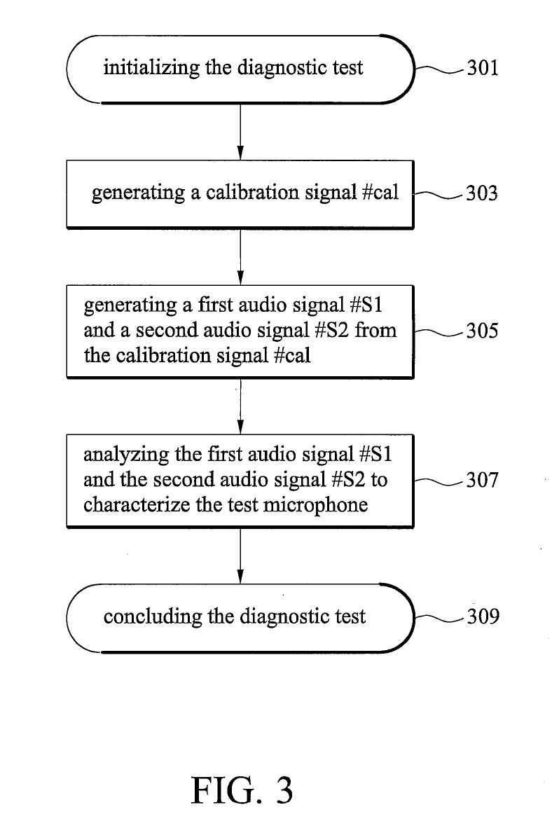

FIG. 3 is a flowchart of a diagnostic test according to the embodiment of FIG. 2. Specifically, the diagnostic test in step 203 will be described in detail. In step 301, the diagnostic test is initialized. In step 303, the calibration signal #cal is generated and broadcasted. In the embodiment, the calibration signal #cal is provided by the DSP 110 and transformed into an analog audio signal by the speaker 108. However, the calibration signal #cal may also be provided by other known devices dedicated to calibrate microphones. Specifically, the calibration signal #cal may be a white noise signal, or a waveform with a certain frequency and certain amplitude. In step 305, the reference microphone 102a and test microphone 102b simultaneously receive the calibration signal #cal to generate a first audio signal #S1 and a second audio signal #S2. Since mismatch occurs between the reference microphone 102a and the test microphone 102b, the difference of the first audio signal #S1 and second audio signal #S2 can be analyzed to determine characteristics of the mismatch. In step 307, characteristics of the test microphone 102b are determined based on the first audio signal #S1 and the second audio signal #S2. In the embodiment, phase mismatch is the primary characteristic to be determined. Sensitivity mismatch, impedance mismatch or other type of mismatches may also be used as characteristics to determine mismatches in the same manner as previously mentioned for phase mismatch. In step 309, when the characteristics of the test microphone 102b are determined, the diagnostic test is concluded.

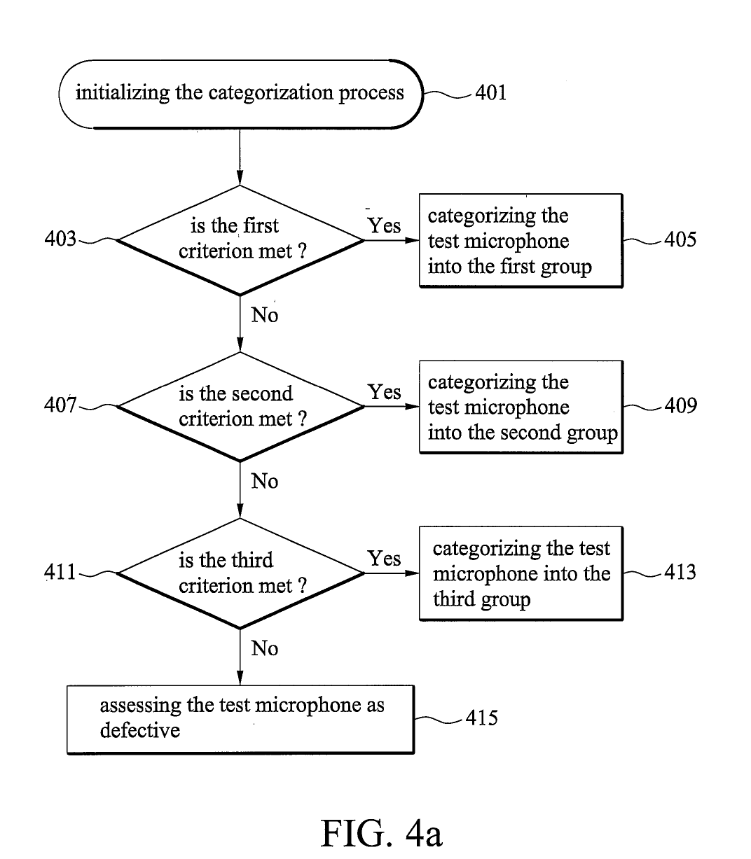

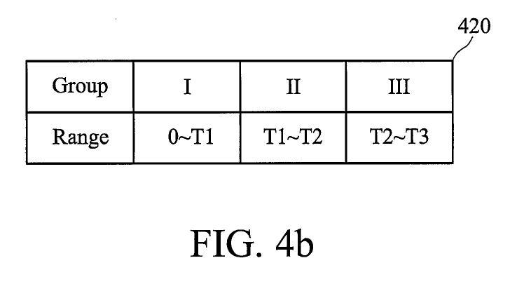

FIG. 4a is a flowchart of a categorization process according to the embodiment of FIG. 2. Specifically, the categorization process in step 205 of FIG. 2 will be described in detail. In step 401, when the characteristics of the test microphone 102b are acquired, the categorization process is initialized. A plurality of criteria is provided, each corresponding to a categorized group. In the embodiment, the criteria are categorized by ranges and sequentially checked. As an example, the strictest criteria range may be compared first and the most relaxed criteria range may be compared last. In step 403, a characteristic is compared with a first criterion. If the first criterion is not met, the second criterion is compared in step 407. If the first criterion is met in step 403, the process goes to step 405, whereby the test microphone 102b is categorized into a first group. If the second criterion is met in step 407, the process goes to step 409, whereby the test microphone 102b is categorized into a second group. There may be a plurality of criterions which can be compared, and the categorization process may be performed to sequentially compare each criterion. For example, step 411 may further check whether a third criterion has been met, and the test microphone 102b may be categorized into a third group, in step 413. If all the criterions listed are not met, step 415 is processed, whereby the test microphone 102b is assessed as being defective. Since the criterions are sequentially checked, a narrower mismatch range criterion should always be checked prior to a wider mismatch range criterion.

Meanwhile, the categorization process may be performed in an alternative manner. FIG. 4b shows a criteria table 420 defining different ranges for each categorized group. For example, group I defines a phase mismatch range of 0 to T1, group II defines a phase mismatch range of T1 to T2, and group III defines a phase mismatch range of T2 to T3. Whereby, test microphones are categorized by searching the criteria table 420. In the embodiment, the categorization process is performed by the DSP 110 with particular designed software. The categorized test microphone 102b may be physically labeled (or marked), such as with a number representing a particular categorized group, so that the microphones are appropriately used for manufacturing of different microphone array types. The categorization platform 100 provided in the invention is particularly adaptable to mass categorization of a plurality of microphones before the microphones are used in the manufacturing of microphone arrays.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A categorization platform for microphone array manufacturing, attachable to a test microphone, comprising:
a reference microphone, wherein the test microphone is positioned at a predetermined distance from the reference microphone; and
a digital signal processor, coupled to the reference microphone and the test microphone, categorizing the test microphone based on comparison of the test microphone and the reference microphone.

2. The categorization platform as claimed in claim 1 further comprising a speaker for generating a calibration signal; wherein:
the digital signal processor performs a diagnostic test to determine characteristics of the test microphone in response to the calibration signal, and
the digital signal processor categorizes test microphone based on characteristics of the test microphone.

3. The categorization platform as claimed in claim 2, wherein when performing the diagnostic test:
the digital signal processor provides a calibration signal to the speaker, whereby a first audio signal and a second audio signal are respectively acquired by the reference microphone and the test microphone; and
the digital signal processor analyzes the first audio signal and the second audio signal to determine characteristics of the test microphone.

4. The categorization platform as claimed in claim 3, wherein when the digital signal processor categorizes the test microphone:
the digital signal processor sequentially compares the characteristics with a plurality of criteria each corresponding to a categorized group, wherein the criteria are sorted by ranges, where the strictest criteria range is compared first and the most relaxed criteria range is compared last; and
if the characteristics meet one of the criteria, the test microphone is categorized into a corresponding group.

5. The categorization platform as claimed in claim 3, wherein when the digital signal processor categorizes the test microphone:
the digital signal processor compares the characteristics with a criteria table comprising a plurality of categorized groups, wherein each categorized group corresponds to a mismatch range;
if the characteristics fall into one of the mismatch ranges, the test microphone is appropriately categorized into the corresponding group; and
if the characteristics do not fall into any of the mismatch ranges, the test microphone is appropriately assessed as being defective.

6. The categorization platform as claimed in claim 3, wherein:
the characteristic comprises phase mismatch between the reference microphone and the test microphone; and
the digital signal processor compares phases of the first audio signal and the second audio signal to determine the phase mismatch.

7. The categorization platform as claimed in claim 3, wherein:
the characteristic comprises sensitivity mismatch between the reference microphone and the test microphone; and
the digital signal processor compares amplitudes of the first audio signal and the second audio signal to determine the sensitivity mismatch.

8. The categorization platform as claimed in claim 3, wherein the characteristic comprises impedance mismatch between the reference microphone and the test microphone.

9. The categorization platform as claimed in claim 1, further comprising:
a first analog to digital converter (ADC), coupled to the reference microphone, digitizing the first audio signal before the first audio signal is sent from the reference microphone to the digital signal processor;
a second ADC, coupled to the test microphone, digitizing the second audio signal before the second audio signal is sent from the test microphone to the digital signal processor; and
a digital to analog converter (DAC), coupled to the speaker, analogizing the calibration signal before the calibration signal is output from the digital signal processor to the speaker.

10. A categorization method for microphone array manufacturing, comprising:
providing a reference microphone and a test microphone, wherein the test microphone is positioned at a predetermined distance from the reference microphone; and
categorizing the test microphone based on comparison of the test microphone and the reference microphone.

11. The categorization method as claimed in claim 10, further comprising:
generating a calibration signal;
respectively acquiring a first audio signal and a second audio signal via the reference microphone and the test microphone;
analyzing the first audio signal and the second audio signal to determine characteristics of the test microphone; and
categorizing the test microphone based on characteristics of the test microphone.

12. The categorization method as claimed in claim 11, wherein the comparison comprises:
sequentially comparing the characteristics with a plurality of criteria each corresponding to a categorized group, wherein the criteria are sorted by ranges, where the strictest criteria range is compared first and the most relaxed criteria range is compared last;
if the characteristics meet one of the criteria, marking the test microphone as belonging to a corresponding group; and
if the characteristics do not meet any of the criteria, marking the test microphone as being defective.

13. The categorization method as claimed in claim 11, wherein the comparison comprises:
comparing the characteristics with a criteria table comprising a plurality of categorized groups, wherein each categorized group corresponds to a mismatch range;
if the characteristics fall into one of the mismatch ranges, marking the test microphone as belonging to the corresponding group; and
if the characteristics do not fall into any of the mismatch ranges, marking the test microphone as being defective.

14. The categorization method as claimed in claim 11, wherein:
the characteristic comprises phase mismatch between the reference microphone and the test microphone; and
the comparison further comprising comparing phases of the first audio signal and the second audio signal to determine the phase mismatch.

15. The categorization method as claimed in claim 11, wherein:
the characteristic comprises sensitivity mismatch between the reference microphone and the test microphone; and
the comparison further comprising comparing amplitudes of the first audio signal and the second audio signal to determine the sensitivity mismatch.

16. The categorization method as claimed in claim 11, wherein the characteristic comprises impedance mismatch between the reference microphone and the test microphone.

17. The categorization method as claimed in claim 11, further comprising:
analogizing the calibration signal before acquiring the first and second audio signals; and
digitizing the first and second audio signals before comparison.

18. A manufacturing method for different types of microphone arrays, comprising:
estimating characteristics of a plurality of test microphones by individually diagnosing each test microphone;
categorizing the test microphones based on characteristics of the test microphones; and
manufacturing different types of microphone arrays using the corresponding categorized test microphones.

19. The manufacturing method as claimed in claim 18, wherein the diagnostic test of a microphone comprises:
generating a calibration signal for a reference microphone and the test microphone, such that a first audio signal and a second audio signal are respectively acquired by the reference microphone and the test microphone; and
comparing the first and second audio signals to determine characteristics of the test microphone.

20. The manufacturing method as claimed in claim 19, wherein categorization of the test microphone comprises:
sequentially comparing the characteristics with a plurality of criteria each corresponding to a categorized group, wherein the criteria are sorted by ranges, where the strictest criteria range is compared first and the most relaxed criteria range is compared last; and
if the characteristics meet one of the criteria, marking the test microphone as belonging to a corresponding group.

21. The manufacturing method as claimed in claim 19, wherein categorization of the test microphone comprises:
comparing the characteristics with a criteria table comprising a plurality of categorized groups, wherein each categorized group corresponds to a mismatch range;
if the characteristics fall into one of the mismatch ranges, marking the test microphone as belonging to the corresponding group; and
if the characteristics do not fall into any of the mismatch ranges, marking the test microphone as being defective.

22. The manufacturing method as claimed in claim 19, wherein:
the characteristic comprises phase mismatch between the reference microphone and the test microphone; and
the diagnostic step comprises comparing phases of the first audio signal and the second audio signal to determine the phase mismatch.

23. The manufacturing method as claimed in claim 19, wherein:
the characteristic comprises sensitivity mismatch between the reference microphone and the test microphone; and
the diagnostic step comprises comparing amplitudes of the first audio signal and the second audio signal to determine the sensitivity mismatch.

24. The manufacturing method as claimed in claim 19, wherein the characteristic comprises impedance mismatch between the reference microphone and the test microphone.

25. The manufacturing method as claimed in claim 19, further comprising:
analogizing the calibration signal before acquiring the first and second audio signals; and
digitizing the first and second audio signals before comparison.
